(19) United States
(12) Patent Application Publication
(10) Pub. No.: US 2025/0361621 A1
(43) Pub. Date: Nov. 27, 2025

(54) A METHOD FOR COATING A COMPONENT OF AN ELECTROLYSER

(71) Applicant: Oort Energy Ltd., Whitchurch, Bristol (GB)

(72) Inventor: Nicholas Joseph Van Dijk, Rotherham, Yorkshire (GB)

(73) Assignee: Oort Energy Ltd., Whitchurch, Bristol (GB)

(21) Appl. No.: 19/108,093

(22) PCT Filed: Aug. 31, 2023
(86) PCT No.: PCT/GB2023/052266

§ 371 Date: Feb. 28, 2025

(30) Foreign Application Priority Data
Sep. 1, 2022 (GB) 2212735.1

(51) Int. Cl. C23C 18/54; C23C 18/44; C25B 9/60

(52) U.S. Cl. CPC C23C 18/54; C23C 18/44; C25B 9/60

(57) ABSTRACT

A method of coating a component of an electrolyser is provided. The method comprises applying an acidic solution of platinum cations to at least a portion of the component and reducing the applied platinum cations with a reducing agent to form a layer of platinum metal on the component.

### FIELD OF THE INVENTION

This invention relates to polymer electrolyte membrane water electrolysers (which are also referred to as electrochemical hydrogen generators), and more particularly, to a method for coating a component of such electrolysers with platinum.

### BACKGROUND

Polymer electrolyte membrane (PEM) water electrolysis cells are electrochemical devices that dissociate water to produce hydrogen and oxygen gases. The hydrogen produced by these devices provides a clean energy fuel source for hydrogen fuel cells. PEM water electrolysis cells include a cathode, an anode and a polymeric electrolyte. Additional components include bipolar plates, porous transport layers, and flow disruptors, which are typically constructed from titanium. Titanium is a preferred metal over iron and nickel-based materials which are prone to degradation.

PEM electrolysis is beneficial over other types of electrolysis because it is more efficient and the hydrogen produced has a high level of purity and can be produced under pressure. However, the efficiency is limited by resistances within the cell. At the beginning of operation, this is dominated by the membrane. However, over time the cell voltage begins to deteriorate. This is primarily due to an increase of the contact resistances within the cell, which is ultimately due to a build-up (thickening) of a titanium dioxide layer on the titanium components. When the titanium dioxide layer reaches a thickness greater than the tunnelling distance of an electron (1.23 nm), an exponential rise in operating voltage results, leading to catastrophic failure of the cell. This typically takes around 5,000-10,000 hours of operation to manifest but can occur sooner or later depending on other factors such as operating conditions and the materials of construction of the balance of plant.

To resolve this issue, the components are typically coated with a precious metal, such as gold or a platinum group metal (e.g. platinum, iridium, palladium, rhodium, or ruthenium). The coating does not need to be continuous as its primary use is metal to metal and metal to catalyst contact resistance.

Two common methodologies for coating titanium components are plating and physical (or chemical) vapour deposition.

Plating encompasses electroplating and electroless plating, both of which involve immersing a component in a solution of metal ions and reducing the metal ions at the surface of the component to produce a metal coating. Electroplating uses electrical current to reduce the metal ions. A drawback of this process is that in order to plate large component parts in a production environment, the plating vessel (containing the plating bath) must be large enough to accommodate the whole component and must accordingly contain considerable quantities of the precious metal. The plating bath is therefore an expensive asset for a company to hold and this results in production costs being high.

Electroless plating creates a metal coating by autocatalytic chemical reduction of the metal cations in which the metal itself acts as a catalytic reducing agent. However, it is unsuitable for coating electrolyser components in a production process because the period required for autocatalysis to complete is too long.

Other electroless coating methods include thermal decomposition methods and powder sintering methods, both of which must be performed at high temperatures (e.g. at greater than about 300° C.). A metal salt solution containing the electrode active coating material is applied, dried, and heat-treated in air at a temperature of, for example, 350° C. to 550° C. Examples of platinum metal salts used in these processes include chloroplatinic acid and dinitrodiamineplatinum. A disadvantage of using these methods is the high operating cost associated with using such elevated temperatures, which limits their use in high volume production processes.

Vapour deposition similarly suffers from drawbacks in that it requires expensive equipment and high vacuum techniques which are difficult to use in large scale production.

There is accordingly a need for a method of coating a component of an electrolyser which addresses the above problems, at least to some extent.

### SUMMARY OF THE INVENTION

In accordance with this invention, there is provided a method of coating a component of an electrolyser, wherein the component comprises titanium, the method comprising:
applying an acidic solution of platinum cations to at least a portion of the component, and
reducing the applied platinum cations with a reducing agent to form a layer of platinum metal on the component.

In contrast to existing coating methods, the method of the present invention is low cost and is suitable for use in high volume manufacturing processes. It can be performed at low temperature (e.g. below 350° C.) and does not result in oxidation of the component's metal.

The method may further comprise at least partially drying the applied acidic solution of platinum cations. The drying may be carried out at a temperature of from about 0° C. to 200° C., from about 25° C. to 175° C., from about 50° C. to 150° C., from about 75° C. to 125° C., from about 80° C. to 100° C., from about 90° C. to 95° C., or at a temperature below about 350° C.

The temperature of the drying step is considerably lower than the temperatures used in thermal decomposition and powder sintering methods of the prior art. This provides a process which is easier to operate and has reduced operating costs.

The acidic solution of platinum cations may be applied to the component in an amount sufficient to provide a platinum loading of from about 0.01 mg/cm² to 2.5 mg/cm² on the component. This loading range is comparable to the catalyst loading of conventional commercial components.

The component may be selected from the group consisting of one or more of a cathode compartment or chamber, an anode compartment or chamber, a bipolar plate, a flow disruptor, and a porous transport layer.

The acidic solution of platinum cations may be applied to the component by one or more methods selected from the group consisting of brushing, dip coating, spraying, and combinations thereof. These application methods ensure an even coating of platinum cations on the component, or a target portion thereof, as required.

The applied platinum cations may be reduced by contact with the reducing agent. The contact may include brushing the applied platinum cations with a solution comprising the reducing agent, immersing the component in a solution comprising the reducing agent, spraying the component with a solution comprising the reducing agent, or a combination thereof. The contact may preferably include immersing the component in a solution comprising the reducing agent. These contacting methods allow for a maximum degree of reduction of the platinum cations to be achieved resulting in a uniform coating of platinum metal on the component.

The method may further comprise at least partially drying the component after reduction of the platinum cations. For example, the drying may be performed after immersion of the component in a solution of the reducing agent. The drying may be carried out at a temperature of from about 0° C. to 200° C., from about 25° C. to 175° C., from about 50° C. to 150° C., from about 75° C. to 125° C., from about 80° C. to 100° C., from about 90° C. to 95° C., or at a temperature below about 350° C.

Drying removes the solvent in which the reducing agent may be present and may serve to accelerate the reduction reaction by concentrating the reducing agent which is in contact with the platinum cations.

The acidic solution of platinum cations may comprise from about 1 wt % to 20 wt %, from about 5 wt % to 15 wt %, or about 10 wt % HCl. The HCl maintains the platinum cations in a charged state and limits side reactions.

The acidic solution of platinum cations may comprise a platinum halide, preferably selected from one or more of platinum chloride, platinum bromide and/or platinum fluoride. The platinum halide may comprise platinum chloride and the platinum chloride may be selected from platinum(IV) chloride, chloroplatinic acid (H₂PtCl₆), and platinum(II) chloride.

The reducing agent may comprise a hydride, a phosphine and/or a borane reducing agent. The hydride reducing agent may be selected from sodium borohydride and/or sodium cyanoborohydride.

### BRIEF DESCRIPTION OF THE FIGURE

In the accompanying FIGURE:

FIG. 1 is a graph illustrating differences in interfacial contact resistance between titanium components which have been coated and undergone an accelerated corrosion test according to the method of the present invention and uncoated titanium components.

### DETAILED DESCRIPTION

As used herein and in the accompanying claims, unless the context requires otherwise, “comprise” or variations such as “comprises” or “comprising” will be understood to imply the inclusion of a stated integer or group of integers but not the exclusion of any other integer or group of integers.

“Consisting essentially of” with respect to the constituents of a component will be understood to mean that the component contains the indicated constituents but may also contain minor trace quantities (i.e. less than 5 wt %, preferably less than 1 wt %) of other constituents or additives without substantially altering the chemical or physical properties of the component.

As used herein, the term “about” in relation to the amounts expressed means that the stated amount can vary by ±5% of the stated amount. For example, about 90 wt % means 90±5 wt %, about 0.1 wt % means 0.1±0.005 wt %, about 80° C. means 80±4° C. When used with reference to a range, the term “about” applies to all values in the range.

As used herein, the term “reducing agent” (also called a reductant or a reducer) refers to a chemical species which participates in a redox reaction by reducing another chemical species. It donates at least one electron and in doing so becomes oxidised. Examples of reducing agents include hydrides, such as metal hydrides (e.g. NaH, LiH, CaH₂, LiAlH₄ and Red-Al) and borohydrides (e.g. NaBH₄, NaBH₃CN and LiBH₄), boranes, and phosphines (e.g. triphenylphosphine). The reducing agent referred to in the present disclosure may comprise one or more chemical species selected from these groups.

The present disclosure provides a method of coating a component of an electrolyser. The coating minimise interfacial contact resistance by preventing titanium dioxide from forming during operation of the electrolyser, which maintains the efficiency of the electrolyser cell and prolongs its lifetime. The method comprises applying an acidic solution of platinum cations to at least a portion of the component and reducing the applied platinum cations with a reducing agent to form a layer of platinum metal on the component. The coating produced may be continuous or discontinuous, or a combination thereof. The degree of continuity of the coating may be determined by electron microscopy, for example, transmission electron microscopy (TEM), scanning electron microscopy (SEM), or scanning transmission electron microscopy (STEM), although any suitable method may be used.

The acidic solution of platinum cations may be applied to the component by one or more application methods selected from the group consisting of brushing, dip coating, spraying, and combinations thereof. More than one application method may be used where the method of the invention is performed in multiple cycles. For example, a first cycle may comprise dip coating and a second cycle may comprise spraying. The use of combinations of different methods may permit a desired platinum loading to be achieved, since different methods typically apply different volumes of solution to the component surface.

The acidic solution of platinum cations may comprise from 0.1 M to 5 M, from 0.5 M to 2 M, from 0.5 to 1.5 M, or about 1M of an acid, or from about 1 wt % to 20 wt %, from about 5 wt % to 15 wt %, or about 10 wt % of an acid. The acid may be selected from HCl, H₂SO₄, HNO₃, and CH₃COOH, and is preferably HCl.

The platinum cations may comprise a platinum halide or dinitrodiamineplatinum. The platinum halide may preferably be selected from one or more of platinum chloride, platinum bromide and/or platinum fluoride. Platinum chlorides are particularly preferred since the chloride anion is also present in the preferred acid, HCl. The platinum chloride may be selected from platinum(IV) chloride, chloroplatinic acid (H₂PtCl₆), and platinum(II) chloride. In a preferred embodiment, the platinum cations comprise chloroplatinic acid.

The acidic solution of platinum cations may be applied to the component in an amount sufficient to provide a platinum loading of from about 0.01 mg/cm² to 2.5 mg/cm², from about 0.01 mg/cm² to 2.0 mg/cm², from about 1.0 mg/cm² to 2.0 mg/cm², from about 1.25 mg/cm² to 1.5 mg/cm², from about 0.1 mg/cm² to 2.0 mg/cm², from about 0.01 mg/cm² to 1.5 mg/cm², or from about 0.01 mg/cm² to 1 mg/cm² on the component. The method may be performed iteratively or more than once (i.e. over multiple cycles) to achieve a desired platinum loading. For example, the method may be performed from 2 to 50 times, from 2 to 20 times, from 2 to 15 times, from 2 to 10 times or from 2 to 5 times.

The method may further comprise at least partially drying the component after application of the solution. The acid solution is typically an aqueous solution and the drying step removes substantially all of the water to leave a residue of the platinum cations on the surface of the component. The drying step may be carried out at a temperature of from about 0° C. to 200° C., from about 25° C. to 175° C., from about 50° C. to 150° C., from about 75° C. to 125° C., from about 80° C. to 100° C., from about 90° C. to 95° C., or at a temperature below about 350° C., 300° C., 250° C., 200° C., 150° C., 100° C. or 95° C. A gas, such as air, may be passed over the surface of the component to accelerate drying. The gas may optionally be heated.

The component may be selected from the group consisting of one or more of a cathode compartment or chamber, an anode compartment or chamber, a bipolar plate, a flow disruptor and a porous transport layer. For example, the component may be a bipolar plate or a porous transport layer. The component may be constructed from a material comprising titanium. The component may consist essentially of titanium prior to coating. For example, the component may be a titanium component. The component may comprise at least 80 wt %, at least 85 wt %, at least 90 wt %, at least 95 wt %, at least 96 wt %, at least 97 wt %, at least 98 wt %, at least 99 wt %, 100 wt % titanium, or a range between any two of these values.

The reducing agent is a chemical reductant which may comprise a hydride, a borane and/or a phosphine reducing agent. Preferably, the reducing agent comprises a hydride, more preferably a borohydride, or even more preferably NaBH₄ and/or NaBH₃CN. The reducing agent may be present as a solution, for example, an aqueous solution.

The reducing step includes contacting the applied platinum cations with the reducing agent. The contact may include brushing the applied platinum cations with a solution comprising the reducing agent, immersing the component in a solution comprising the reducing agent, spraying the component with a solution comprising the reducing agent, or a combination thereof. The contacting may preferably include immersing the component in a solution comprising the reducing agent. The component may be washed to remove any salts or impurities remaining after the reduction.

The method may further comprise at least partially drying the component. When the reducing agent is present as a solution, it is typically present as an aqueous solution and the drying step removes any water which may be present on the surface of the component. The drying step may be carried out at a temperature of from about 0° C. to 200° C., from about 25° C. to 175° C., from about 50° C. to 150° C., from about 75° C. to 125° C., from about 80° C. to 100° C., from about 90° C. to 95° C., or at a temperature below about 350° C., 300° C., 250° C., 200° C., 150° C., 100° C. or 95° C. A gas, such as air, may be passed over the surface of the component to accelerate drying. The gas may optionally be heated.

### Example

A piece of titanium sheet metal cut and machined to size (20 cm×20 cm) was first cleaned in water then degreased in a batch of acetone in an ultrasonic bath for about 10 minutes. After drying the piece was rinsed three times with deionised water. A coating solution was made by dissolving 10 g of chloroplatinic acid (H₂PtCl₆) in a 1M hydrochloric acid solution. The solution was applied to the previously prepared titanium piece by brushing, reaching a chloroplatinic acid salt solution loading of 12.5-15.0 g/m². The coated part was dried at 90° C. and reweighed to ensure a loading of 1.25-1.5 g/m² of H₂PtCl₆. The dried part was instantaneously then dipped into a 1M Na₂BH₄ solution for 2 seconds. The platinum salt was reduced to platinum on the surface of the titanium, as evidenced by the appearance of bubbles of hydrogen on the surface of the part.

To simulate the effects of accelerated corrosion in an electrolyser cell the titanium part was placed in an aqueous solution containing 1 mg/l NaF (2.4×10⁻⁵ M) for 1 hour. An uncoated (degreased) titanium part was placed in the same solution for the same amount of time. After 1 hour both parts were rinsed in deionised water and dried at 90° C.

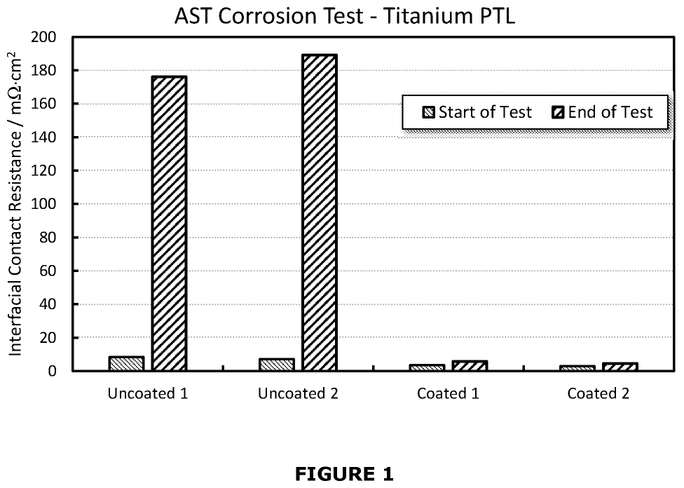

The contact resistance of the parts was measured by placing 1 cm² gold coated copper disc on the surface with a pressure of 1.96 N/cm². A current of 1 A was passed between the copper disc and the titanium part and the voltage between the copper disc and the titanium was measured using a calibrated digital voltmeter. Using Ohms law the voltage was converted directly into a contact resistance in Ω·cm². The coated part had a contact resistance of between 1 and 6 mΩ·cm², whereas the uncoated part had a contact resistance above 100 mΩ·cm². The results are provided in Table 1 below and illustrated in FIG. 1.

TABLE 1
Interfacial Contact Resistance

| | Start of Test | End of Test |
|---|---|---|
| Uncoated 1 | 8.4 | 176 |
| Uncoated 2 | 7.2 | 189 |
| Coated 1 | 3.6 | 5.8 |
| Coated 2 | 2.8 | 4.5 |

1. A method of coating a component of an electrolyser, wherein the component comprises titanium, the method comprising:
applying an acidic solution of platinum cations to at least a portion of the component, and
reducing the applied platinum cations with a reducing agent to form a layer of platinum metal on the component.

2. The method of claim 1, further comprising at least partially drying the applied acidic solution of platinum cations.

3. The method of claim 2, wherein the drying is carried out at a temperature of from 0° C. to 200° C., from about 25° C. to 175° C., from about 50° C. to 150° C., from about 75° C. to 125° C., from about 80° C. to 100° C., from about 90° C. to 95° C., or at a temperature below about 350° C.

4. The method of claim 1, wherein the acidic solution of platinum cations is applied to the component in an amount sufficient to provide a platinum loading of from 0.01 to 2.5 mg/cm² on the component.

5. The method of claim 1, wherein the component is selected from one or more of a cathode compartment or chamber, an anode compartment or chamber, a flow disruptor and a bipolar plate.

6. The method of claim 1, wherein the component is a titanium component.

7. The method of claim 1, wherein the acidic solution of platinum cations is applied to the component by a method selected from the group consisting of brushing, dip coating, spraying, or a combination thereof.

8. The method of claim 1, wherein the reducing includes brushing the applied platinum cations with a solution comprising the reducing agent, immersing the component in a solution comprising the reducing agent, spraying the component with a solution comprising the reducing agent, or a combination thereof.

9. The method of claim 1, wherein the reducing comprises immersing the component in a solution comprising the reducing agent.

10. (canceled)

11. The method of claim 1, wherein the acidic solution of platinum cations comprises from 1 wt % to 20 wt %, from 5 wt % to 15 wt %, or 10 wt % HCl.

12. The method of claim 1, wherein the acidic solution of platinum cations comprises a platinum halide, preferably selected from one or more of platinum chloride, platinum bromide and/or platinum fluoride.

13. The method of claim 12, wherein the platinum halide comprises platinum chloride and the platinum chloride is selected from platinum(IV) chloride, chloroplatinic acid (H₂PtCl₆), and platinum(II) chloride.

14. The method of claim 1, wherein the reducing agent comprises a hydride, phosphine and/or borane reducing agent.

15. The method of claim 14, wherein the hydride reducing agent is selected from sodium borohydride and/or sodium cyanoborohydride.
